(19) United States
(12) Patent Application Publication
(10) Pub. No.: US 2026/0180156 A1
(43) Pub. Date: Jun. 25, 2026

(54) ANTENNA DEVICE INTEGRABLE IN AN ELECTRONIC INSTRUMENT CASE

(71) Applicant: The Swatch Group Research and Development Ltd, Marin (CH)

(72) Inventors: Zoran Randjelovic, Corcelles (CH); Jean-Claude Martin, Montmollin (CH); Jean Gorisse, Neuchâtel (CH); Alexis Pintore, Cernier (CH); Yasmine El Sayed, Lausanne (CH)

(73) Assignee: The Swatch Group Research and Development Ltd, Marin (CH)

(21) Appl. No.: 19/388,263

(22) Filed: Nov. 13, 2025

(30) Foreign Application Priority Data
Dec. 19, 2024 (EP) 24221710.7

(51) Int. Cl. H01Q 1/24; H01Q 1/22

(52) U.S. Cl. CPC H01Q 1/241; H01Q 1/225; H01Q 1/2266

(57) ABSTRACT

An antenna device designed to be integrated in a case (2) in which at least one part is electrically conductive, particularly in a case (2) of a wearable electronic instrument (1), the device (3) including: a first antenna part (4A) designed to be connected by a first connector (8A) to a function module (7) positioned on a circuit board (10) inside the case (2), and a second antenna part (4B) includinng a ground plane having the at least electrically conductive part of the case (2) to which a second connector (8B) in the first antenna part (4A) is connected via an electronic module (4C) for tuning a resonance frequency and increasing the efficiency of the antenna device (3) according to an angular position of the device (3).

### CROSS-REFERENCE TO RELATED APPLICATION

This application claims priority to European Patent Application No. 24221710.7 filed on Dec. 19, 2024, the content of which is hereby incorporated by reference in its entirety into this application.

### Technical Field of the Invention

The invention relates to the field of antennas embedded in electronic instruments such as watches, in which the cases are small or comprise compartments with small volumes for accommodating an antenna device.

### Technological Background

State-of-the art antenna devices are commonly integrated into metal cases in electronic instruments to receive GNSS signals for use in navigation or guidance systems implemented in the instruments.

However, one of the major problems with this configuration is that the mechanical characteristics, such as the shape and arrangement of the metal case or the presence of other metal components or parts in the case have a significant impact on the performance of the antenna device. In fact, this performance is seriously altered compared to what it would be in a context in which this antenna device was not integrated into such a metal case and thus enclosed. Indeed, the mechanical environment of such an antenna device has a strong impact on its performance, reducing in particular its performance in terms of tuning, gain, radiation, etc.

In general, the prior art discloses various methodologies for designing antenna devices, especially miniature ones, and in particular with transmission/reception characteristics in the frequency bands used for GNSS signals.

However, there is no known satisfactory solution for optimising the performance of such antenna devices designed to be enclosed in metal cases.

Given these conditions, there is clearly a need to find alternative solutions to the ones in the prior art.

### SUMMARY OF THE INVENTION

The invention aims to improve the performance of an antenna device arranged in a small case comprising at least one metal part and/or integrating at least one metallic element in its compartment.

The invention also aims to ensure or guarantee optimum reception of electromagnetic signals by this antenna device, irrespective of the orientation or position of this device relative to the source emitting these electromagnetic signals.

The invention relates to an antenna device designed to be integrated in a case in which at least one part is electrically conductive, particularly in a case of a wearable electronic instrument, the device comprising:
a first antenna part designed to be connected by a first connector to a function module positioned on a circuit board inside said case, and
a second antenna part consisting of a ground plane comprising said at least electrically conductive part of the case to which a second connector in the first antenna part is connected via an electronic module for tuning a resonance frequency and increasing the efficiency of the antenna device according to an angular position of said device.

Another aspect of the invention relates to:
said electronic module comprises an electric circuit that is dynamically configurable according to the angular position of the antenna device and a module for detecting a change in angular position of this antenna device;
the electric circuit comprises two components: a coil and a capacitor;
the electric circuit comprises three switches that are provided to configure this electric circuit in first and second configuration modes in which a coil and a capacitor are respectively arranged in series and in parallel;
inductance values for the coil and capacitance values for the capacitor in the first and second configuration modes are chosen so as to satisfy the following equation:

$${L}_{series} \times {C}_{series} = {L}_{parallel} \times {C}_{parallel} .$$

the detection module comprises at least one angular position sensor and a processing unit;
the antenna device is configured to receive one or more GNSS signals transmitted by GNSS sources in a given frequency band;
the antenna device is configured to radiate in a frequency band corresponding to a wavelength λ, the form of the first antenna part and its length being configured such that this first antenna part has an electrical measurement length λ/4;
the frequency band is comprised between 1,559 MHz and 1,610 MHz.

In another aspect, the invention relates to an electronic instrument worn by a wearer comprising a case provided with at least one electrically conductive part configured to come into contact with a part of the wearer's body, said case holding an antenna device according to any of the preceding claims and a circuit board comprising:
the function module, which is electrically connected to the first connector on the first antenna part, and
the electronic module for tuning a resonance frequency and increasing the efficiency of the antenna device according to an angular position of this device, this electronic module being electrically connected to the second connector and to the ground plane on the antenna device.

Advantageously, the ground plane comprises a first part comprised on the circuit board and a second part comprising the at least electrically conductive part of the case.

In particular, the function module is a GNSS signal receiver module comprising a radio frequency circuit.

Advantageously, the electronic instrument is a watch, in particular a wristwatch.

### BRIEF DESCRIPTION OF THE FIGURES

Other features and advantages of the invention will be more clearly apparent from reading the following description of a particular embodiment of the invention, provided merely as an illustrative and non-limiting example, and from the appended figures, among which:

FIG. 1 is a schematic view of the case of the electronic instrument, in this example a watch, comprising the antenna device, according to the embodiments of the invention;

FIG. 2A is a design plan for an electric circuit in which the components, such as a coil and a capacitor, can be configured in this circuit to be arranged in series or in parallel, according to the embodiments of the invention;

FIG. 2B is a design plan for the electric circuit with the coil and capacitor configured in series in this circuit, according to the embodiments of the invention;

FIG. 2C is a design plan for the electric circuit with the coil and capacitor configured in parallel in this circuit, according to the embodiments of the invention;

FIG. 3 is a radiation pattern of the antenna device integrated into the case of the electronic instrument, in this example a watchcase, when this case is arranged in a horizontal position, according to the embodiments of the invention, and

FIG. 4 is a radiation pattern of the antenna device integrated into the case of the electronic instrument, in this example a watchcase, when this case is arranged in a vertical position, according to the embodiments of the invention.

### DETAILED DESCRIPTION OF THE INVENTION

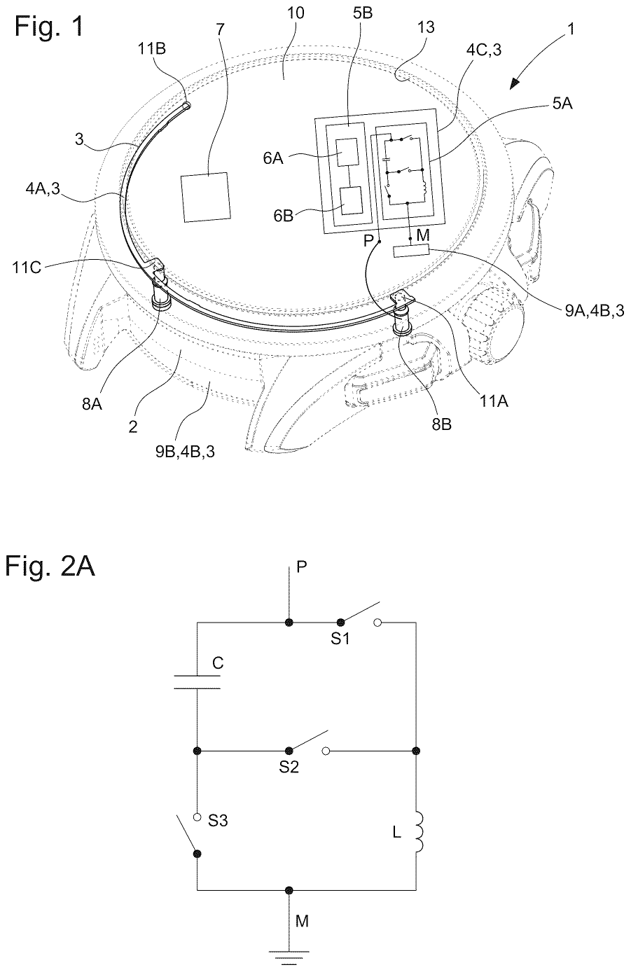

FIGS. 1 to 4 relate to an antenna device 3, in particular a beam or directional antenna device, that can radiate or receive more power in specific directions. This antenna device 3 is designed to be integrated into a case 2 of an electronic instrument 1.

Such an electronic instrument 1 is a communicating object with a case 2 that is small compared to the wavelengths used for communication. Typically, the case 2 of this object to which the invention relates has dimensions of around a few centimetres.

In one potential application, this antenna device 3 is integrated into a navigation or guidance system implemented in this electronic instrument 1 by being enclosed in a case 2, at least part of which is electrically conductive. Such an electronic instrument 1 is preferably a watch, but in other alternatives, this instrument 1 can be, in a non-limiting and non-exhaustive manner, a portable or wearable object such as a smartphone, a band such as a ring, a habitronic, etc. However, it is understood that other applications can be considered for such an invention, as long as a small antenna device 3 is enclosed in a case that is also small.

This watch 1 is, for example, a conventional wristwatch comprising, in addition to the antenna device 3, the case 2, a wristlet attached to said case 2, a glass under which is a display device enclosed in the case 2, and control organs. The display device comprises, in this particular case, an analogue display comprising two or three hands moving opposite a dial, in particular to allow for conventional time telling, and can be supplemented by a digital display using LCD or OLED display technologies.

In this watch 1, the case 2 comprises a circuit board 10 with numerous compartments for holding a plurality of electronic and electrical components of the watch 1, including elements of the antenna device 3. These electronic and electrical components comprise in particular a motor with its axes for driving the hands, a first electrically conductive part 9A of a ground plane on the antenna device 3 and a source of electrical energy powering in particular the display device, a function module 7 and an electronic module 4C included in this antenna device 3. This electrical power source can consist of a conventional cell or battery, a rechargeable accumulator or any other suitable electrical energy source.

In the context of a watch 1 implementing a navigation or guidance system, this antenna device 3 is configured to receive one or more GNSS signals transmitted by GNSS sources, in a frequency band used by a constellation of global positioning satellites. In other words, it is configured to receive satellite positioning and navigation signals, such as GPS signals from the U.S. NAVSTAR satellite positioning system or other positioning signals from similar systems such as the Chinese BEIDOU system, the Russian GLONASS system or the European GALILEO satellite positioning and navigation system.

Under these conditions, this antenna device 3 is thus configured to receive signals belonging to at least one frequency band comprised between 1,559 MHz and 1,610 MHz. More specifically, it is configured to receive signals comprised in at least one of the following frequency bands:
1,559 to 1,610 MHz, which covers frequencies L1, E1, B1;
1,215 to 1,300 MHz, which covers frequencies L2, E6, B3, L6;
1,164 to 1,215 MHz, which covers frequencies L5, E5, B2, L3.

In the embodiment described herein, it will be assumed that the antenna device 3 is configured to receive a signal with a frequency L1 of approximately 1,575.42 MHz.

As is known in the prior art, metallic components comprised in the case 2, or even metal parts of this case 2 that typically encloses an antenna device, are capable of forming masks that reduce the performance of such a device. Given this context, the invention proposes to form an antenna device 3 comprising two parts 4A, 4B, namely, a first part 4A with an IFA (“inverted F antenna”) structure suitable for being connected to a function module 7 comprised on the circuit board 10 and a second part 4B consisting of the ground plane 9A, 9B comprising an at least electrically conductive part of the case 2.

Thus, with reference to FIG. 1, the first antenna part 4A consists of a segment or of a strand with a curved shape. This segment is an electrically conductive element which acts as a radiating element for the antenna device 3 and which is oriented parallel to a plane comprising an opening 13 made in the face of the case 2, this opening 13 being designed to be closed by the glass of this watch 1.

This segment has a length equal to a fraction of an incident electromagnetic wavelength to be received and which is converted into an electrical signal received by the function module 7. More specifically, this segment is configured to radiate in a frequency band corresponding to wavelength λ, its shape, as well as its length, being configured such that it has an electrical length of λ/4. In this embodiment, the antenna device 3 radiates in response to a received electromagnetic wave with a frequency L1 of 1,575.42 MHz. In this configuration, the length of the segment is then comprised between 44 and 46 mm, and preferably 45.7 mm.

It should be noted that in this case 2 of the watch 1, the first antenna part 4A, and in particular the segment, is arranged above the dial, for example in the bezel or even in the flange of this watch 1, being oriented parallel to the plane comprising the opening referenced 13 of the case 2. In this context, this bezel and this flange are made of a non-conductive (dielectric) material such as a plastic, enabling the antenna device 3 to be electrically isolated from the case 2.

This first antenna part 4A comprises a first connector 8A comprised substantially in the middle of the segment, that is, in a portion 11C located between the two ends 11A, 11B of this segment. This first connector 8A, also referred to as the “antenna foot” or “antenna feed”, is configured to be connected to the function module 7 to be positioned on the circuit board 10 arranged in the case 2.

This function module 7 is a GNSS signal receiver module comprising a radio frequency circuit. In this embodiment, it is configured to receive a specific L1 type satellite radio signal associated with a carrier frequency and a bandwidth. This function module 7 is electrically powered by the electrical energy power source.

This first antenna part 4A also comprises a second connector 8B comprised at one of the two ends 11A, 11B of the segment. This second connector 8B, also referred to as the “antenna load”, is configured to be connected to the ground plane 9A, 9B via the electronic module 4C for tuning a resonance frequency and increasing the efficiency of the antenna device 3.

As has already been mentioned, this electronic module 4C of the antenna device 3 is arranged on the circuit board 10. Such a module 4C consists of an electric circuit 5A that can be dynamically configured according to the angular position of the antenna device 3, and a module 5B for detecting changes in the angular position of this device 3.

In this module 4C, the detection module 5B comprises at least one angular position sensor 6A comprising, in a non-limiting and non-exhaustive manner, an inertial unit and/or a gyroscopic sensor. This detection module 5B also comprises a processing unit 6B such as a microcontroller. This processing unit 6B is designed to control/drive the configuration of the electric circuit 5A according to measurements of the angular position of the case 2, and therefore of the antenna device 3, which it can receive from said sensor 6A.

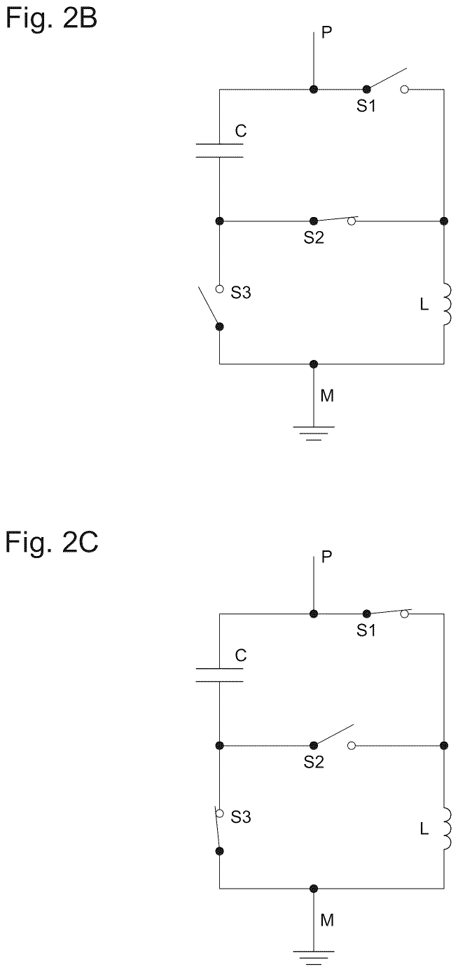

Referring to FIGS. 1 and 2A, this electric circuit 5A comprises a first connection point P electrically connected to the second connector 8B and a second connection point M connected to the first part of the ground plane 9A on the antenna device 3, defined on the circuit board 10.

In this configuration, such an electric circuit 5A is configured to act on the load of the first antenna part 4A and not on its power supply. Under these conditions, this electric circuit 5A comprises two components: a coil L and a capacitor C. It also comprises three switches S1, S2, S3 whose closing and opening are controlled by the processing unit 6B in order to set/configure the electric circuit 5A in:
a first configuration mode as shown in FIG. 2B, in which the coil L and capacitor C are arranged in series by closing switch S2 and opening switches S1 and S3, and
a second configuration mode as shown in FIG. 2C, in which the coil L and capacitor C are arranged in parallel, by closing switches S1 and S3 and opening switch S2.

These two configuration modes of the electric circuit 5A act differently on the load of the first antenna part 4A, by generating a displacement of the minima and maxima of the radiation of this first antenna part 4A, that is, by varying the gain of the antenna device 3 in a spatial direction according to different angular positions of the case 2 and therefore of the antenna device 3.

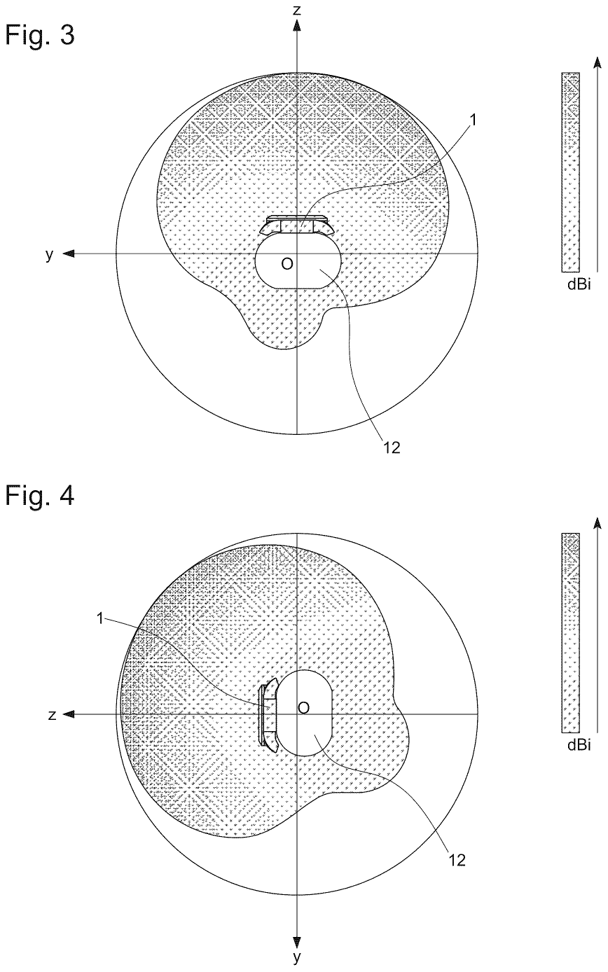

For example, when the case 2 is in a “horizontal” position, the upper face of the first antenna part 4A is arranged facing or substantially facing the GNSS source. Under these conditions, the electric circuit 5A is then configured by the processing unit 6B in the first configuration mode. In this first mode, the radiation pattern of the antenna device 3 as shown in FIG. 3 conventionally defines the spatial power distribution of the antenna device 3. This radiation pattern describes the direction in which this antenna device 3 radiates with the most power, in this case the direction of the Oz axis.

In the radiation pattern in FIG. 3, it can be seen that:
the maximum gain is −10.77 dBi —
the opening at 3 dB is 157.6 degrees

In another example, when the case 2 moves from the horizontal position to a new position, in this case a vertical position, the electronic module 4C then detects this change in the angular position of the case 2. Under these conditions, this electronic module 4C then configures the electric circuit 5A in the second configuration mode. In this context, the radiation pattern of the antenna device 3 as shown in FIG. 4 describes a direction in which the antenna device 3 radiates with the most power, in this case a direction comprised between the directions of the Oy and Oz axes.

In the radiation pattern in FIG. 4, it can be seen that:
the maximum gain is -10.65 dBi —
the opening at 3 dB is 147.2 degrees

It should be noted that in these radiation patterns, the case 2 of the watch 1 is attached to the wearer's wrist 12. Moreover, it should be noted that spherical coordinate angles (θ, φ) are used, as shown in FIGS. 3 and 4. Angle “θ” is marked relative to the Oz axis and angle “φ” lies in the xOy plane and is marked relative to the Ox axis.

In this electric circuit 5A, when the capacitor C and the coil L are used in the first and second configuration modes of the circuit 5A, the capacitance values Cₛₑᵣᵢₑₛ, Cₚₐᵣₐₗₗₑₗ for the capacitor C and the inductance values Lₛₑᵣᵢₑₛ, Lₚₐᵣₐₗₗₑₗ for the coil L are chosen so that the following equation is satisfied:

$${L}_{series} \times {C}_{series} = {L}_{parallel} \times {C}_{parallel}$$

wherein:
Lₛₑᵣᵢₑₛ and Cₛₑᵣᵢₑₛ represent the inductance and capacitance values for the coil L and the capacitor C in the first configuration of the circuit 5A;
Lₚₐᵣₐₗₗₑₗ and Cₚₐᵣₐₗₗₑₗ represent the inductance and capacitance values for the coil L and the capacitor C in the second configuration of the circuit 5A.

The selection or choice of these inductance and capacitance values from this equation helps to ensure that the load resonates at the correct frequency. It also helps increase the efficiency of the antenna device, as illustrated by the radiation patterns shown in FIGS. 3 and 4.

As has been previously mentioned, the antenna device 3 also comprises the second antenna part 4B consisting of the ground plane 9A, 9B. This ground plane 9A, 9B is an enlarged ground plane as it consists of the first and second parts 9A, 9B of this plane, the second part 9B comprising said at least electrically conductive part of the case 2. This ground plane is connected to the second connector 8B on the first antenna part 4A via the electronic module 4C.

In this ground plane, the first part 9A is connected to the second part 9B via a conductor track. The circuit board 10 can in fact comprise such a conductor track on a lower face of the plate 10. This track is thus electrically connected to the first part 9A of the ground plane. This conductor track can be arranged on the periphery of the circuit board 10 and is located in particular in a mechanical contact zone between the circuit board 10 and the at least electrically conductive part of the case 2 via, for example, a shoulder on the body of this at least electrically conductive part. Preferably, this conductor track can extend around essentially the entire periphery of the circuit board 10, although this conductor track can be interrupted at one or more points around the periphery. Locating the track around virtually the entire periphery of the circuit board 10 has the advantage of improving the quality of the electrical contact with the electrically conductive part of the case 2. It is understood that this configuration maximises the surface area of the ground plane by extending it to the electrically conductive part of the case 2. Moreover, this enlargement of the ground plane on the antenna device improves the detection sensitivity of the antenna device.

It should be noted that the electrically conductive part is made of an electrically conductive material, preferably metal (for example steel, titanium or aluminium), or of a base material covered with an electrically conductive outer layer. This electrically conductive part preferably comprises a zone or a portion of this case 2 that is designed to be in contact with a part 12 of the wearer's/user's body such as their wrist, which can be the back of this case 2, for example.

With the device according to the invention, this antenna device 3 can be integrated into this case 2 of the watch 1, while using part of said metal case 2 to optimise the performance of this antenna device 3. Furthermore, as has been seen, the electronic module 4C included in this antenna device 3 makes it possible to integrate “beamforming” and “beamsteering” techniques into the functions of this device 3 and also to improve the performance of this antenna device 3, particularly in terms of gain, tuning, efficiency and radiation.

Thus a watch 1 fitted with this antenna device 3 and worn on the wearer's wrist 12 can optimally receive GNSS signals regardless of its position or its orientation relative to the receiving zone for these GNSS signals induced by the movement of this wearer's wrist when the wearer is engaged in a physical or sporting activity (hiking, cycling, etc.).

The present invention is designed in particular for use in the horology field, but can also be used in other fields.

It is further specified that the present invention is not limited to the examples described above and that numerous variants may be available to the person skilled in the art.

### TERMINOLOGY

1. Electronic instrument
2. Case
3. Antenna device
4A. First antenna part
4B. Second antenna part
4C. Electronic module
5A. Dynamically configurable electric circuit
5B. Angular position change detection module
6A. Angular position sensor
6B. Processing unit
7. Function module
8A. First connector in the first antenna part
8B. Second connector in the first antenna part
9A. First part of the ground plane on the antenna device
9B. Second part of the ground plane comprising the electrically conductive part of the case
10. Circuit board
11A. First end of the first antenna part
11B. Second end of the first antenna part
11C. Portion located approximately equidistant from the ends of the segment
12. Wearer's body part, such as their wrist
13. Opening in the face of the case

1. An antenna device (3) designed to be integrated in a case (2) in which at least one part is electrically conductive, particularly in a case (2) of a wearable electronic instrument (1), the device (3) comprising:
a first antenna part (4A) designed to be connected by a first connector (8A) to a function module (7) positioned on a circuit board (10) inside said case (2), and
a second antenna part (4B) including a ground plane comprising said at least electrically conductive part of the case (2) to which a second connector (8B) in the first antenna part (4A) is connected via an electronic module (4C) for tuning a resonance frequency and increasing the efficiency of the antenna device (3) according to an angular position of said device (3).

2. The antenna device (3) according to claim 1, wherein said electronic module (4C) comprises an electric circuit (5A) that is dynamically configurable according to the angular position of the antenna device (3) and a module (5B) for detecting a change in angular position of this antenna device (3).

3. The antenna device (3) according to claim 1, wherein the electric circuit (5A) comprises two components: a coil (L) and a capacitor (C).

4. The antenna device (3) according to claim 1, wherein said electronic module (4C) comprises an electric circuit (5A) that is dynamically configurable according to the angular position of the antenna device (3) and a module (5B) for detecting a change in angular position of this antenna device (3), the electric circuit (5A) comprising three switches (S1, S2, S3) that are provided to configure this electric circuit (5A) in first and second configuration modes in which a coil (L) and a capacitor (C) are respectively arranged in series and in parallel.

5. The antenna device (3) according to claim 1, wherein said electronic module (4C) comprises an electric circuit (5A) that is dynamically configurable according to the angular position of the antenna device (3) and a module (5B) for detecting a change in angular position of this antenna device (3), the electric circuit (5A) comprising three switches (S1, S2, S3) that are provided to configure this electric circuit (5A) in first and second configuration modes in which a coil (L) and a capacitor (C) are respectively arranged in series and in parallel, inductance values (Lₛₑᵣᵢₑₛ, Lₚₐᵣₐₗₗₑₗ) for the coil (L) and capacitance values (Cₛₑᵣᵢₑₛ, Cₚₐᵣₐₗₗₑₗ) for the capacitor (C) in the first and second configuration modes being chosen so as to satisfy the following equation:
$${L}_{series} \times {C}_{series} = {L}_{parallel} \times {C}_{parallel} .$$

6. The antenna device (3) according to claim 1, wherein the detection module (5B) comprises at least one angular position sensor (6A) and a processing unit (6B).

7. The antenna device (3) according to claim1, wherein it is configured to receive one or more GNSS signals transmitted by GNSS sources in a given frequency band.

8. The antenna device (3) according to claim 1, wherein it is configured to radiate in a frequency band corresponding to a wavelength λ, the form of the first antenna part (4A) and its length being configured such that this first antenna part (4A) has an electrical measurement length λ/4.

9. The antenna device (3) according to claim 1 wherein it is configured to radiate in a frequency band corresponding to a wavelength λ, the form of the first antenna part (4A) and its length being configured such that this first antenna part (4A) has an electrical measurement length λ/4, the frequency band being comprised between 1,559 MHz and 1,610 MHz.

10. An electronic instrument (1) worn by a wearer comprising a case (2) provided with at least one electrically conductive part configured to come into contact with a part (12) of the wearer's body, said case (2) holding the antenna device (3) according to claim 1 and a circuit board (10) comprising:
the function module (7), which is electrically connected to the first connector (8A) on the first antenna part (4A), and
the electronic module (4C) for tuning a resonance frequency and increasing the efficiency of the antenna device (3) according to an angular position of this device (3), this electronic module (4C) being electrically connected to the second connector (8B) and to the ground plane on the antenna device (3).

11. The electronic instrument (1) according to claim 10, wherein the ground plane comprises a first part (9A) comprised on the circuit board (10) and a second part (9B) comprising the at least electrically conductive part of the case (2).

12. The electronic instrument (1) according to claim 10, wherein the function module (7) is a GNSS signal receiver module comprising a radio frequency circuit.

13. The electronic instrument (1) according to claim 10 comprising a wristwatch.
